(19) United States
(12) Patent Application Publication
(10) Pub. No.: US 2026/0287156 A1
(43) Pub. Date: Sep. 24, 2026

(54) ELECTROMOTIVE LIGHTING

(71) Applicant: Aristocrat Technologies, Inc., Las Vegas, NV (US)

(72) Inventors: Stephen Shaffer, JR., Las Vegas, NV (US); Paul Barker, Henderson, NV (US); Richard Walkup, II, Las Vegas, NV (US)

(21) Appl. No.: 19/568,548

(22) Filed: Mar. 16, 2026

Related U.S. Application Data
(60) Provisional application No. 63/775,206, filed on Mar. 20, 2025.

(51) Int. Cl. F21V 21/15; F21Y 115/10

(52) U.S. Cl. CPC F21V 21/15; F21Y 2115/10

(57) ABSTRACT

Electromotive lighting assemblies having one or more light-emitting diodes or other light-emitting devices mounted to a movable substrate are provided. In some instances, the substrate may be a flexible printed circuit, or mounted to a flexible printed circuit, that may incorporate an inductive coil and may be mounted adjacent to a magnet. When current is applied to the inductive coil, the resulting magnetic field may be repelled by the magnetic field of the magnet and may cause the flexible printed circuit to move away from the magnet, thereby causing the light-emitting device supported by the flexible printed circuit to move. By arranging multiple such electromotive lighting assemblies in an array, e.g., a linear or rectangular array, an electromotive lighting module may be produced that may allow for visual effects to be generated.

### RELATED APPLICATION(S)

This application claims benefit of priority under 35 U.S.C. §119 to U.S. Patent Application No. 63/775,206, filed Mar. 20, 2025, and titled “ELECTROMOTIVE LIGHTING,” which is hereby incorporated herein by reference in its entirety.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

Discussed herein are various lighting modules that each include a plurality of electromotive lighting assemblies (ELAs), e.g., one or more lights that may be connected with an electromotive actuator that allows the one or more lights to be moved in one or more directions responsive to a control signal. The resulting lighting modules may be configured to allow each ELA to be individually controlled for both light source light emission (color and intensity) and electromotive actuation (to control displacement or movement of the light source). This may allow for lighting displays in which the light sources may individually move (or where small groups of light sources may move as a group) relative to one another in order to generate unique optical effects. Such lighting modules may be relatively inexpensive to manufacture compared to other lighting module types.

In some implementations, an apparatus may be provided that includes a plurality of electromotive lighting assemblies (ELAs) and one or more controllers. Each ELA may include: a flexible substrate having an electrically conductive coil located therein or thereon and in between a first end of the flexible substrate and a second end of the flexible substrate (where the flexible substrate is configured to be able to flex between at least a first position and a second position), one or more light sources located at the first end of the flexible substrate, and a magnet that is mounted in a fixed location relative to the second end of the flexible substrate. The magnet may be positioned adjacent the electrically conductive coil when the flexible substrate is in the first position. The ELAs may be arranged along a path or in a two-dimensional pattern and the one or more controllers may be operably connected with the one or more light sources and the electrically conductive coil in each of the ELAs and configured to control a light emission state of each of the one or more light sources in each of the ELAs and to control movement of the flexible substrate in each of the ELAs from the corresponding first position to the corresponding second position.

In some implementations, the apparatus may include a contiguous flexible substrate. The flexible substrate of each ELA may be provided by a corresponding sub-portion of the contiguous flexible substrate, and the contiguous flexible substrate may have, for each ELA, a cut-away portion separating the first end of the flexible substrate of that ELA, as well at least one side of the flexible substrate of that ELA extending from the first end of the flexible substrate of that ELA towards the second end of the flexible substrate of that ELA, from portions of the contiguous flexible substrate adjacent that ELA.

In some implementations, for each ELA in a set of the ELAs, the flexible substrate of that ELA may have a through-hole located in between the second end of the flexible substrate of that ELA and the electrically conductive coil of that ELA.

In some implementations, for each ELA in a first set of the ELAs, the one or more light sources for that ELA may include surface-mount light-emitting diodes.

In some implementations, for each ELA in the first set of the ELAs, the one or more light sources of that ELA may include multiple light sources.

In some implementations, for each ELA in a second set of the ELAs in the first set of the ELAs, the first end of the flexible substrate of that ELA may define a rounded or faceted edge and the multiple light sources of that ELA are arranged adjacent the rounded or faceted edge such that they have different directions of maximum light emission intensity when caused to emit light.

In some implementations, the ELAs may be arranged along a path, one after another.

In some implementations, the ELAs may be arranged in a two-dimensional pattern.

In some implementations, for each ELA in a first set of the ELAs, at least part of the first end of the flexible substrate for that ELA may be located in between the first end and the second end of the flexible substrate for an ELA in a second set of the ELAs, and each ELA in the first set of ELAs may be adjacent to at least one ELA in the second set of ELAs.

In some implementations, the contiguous flexible substrate may be arranged to overlap itself in between the second ends of the substrates in the first set of the ELAs and the second ends of the substrates in the second set of the ELAs.

In some implementations, for each ELA in the first set of the ELAs, another part of the first end of the flexible substrate for that ELA may be located in between the first end and the second end of the flexible substrate for another ELA in the second set of the ELAs.

In some implementations, each ELA may have a reference axis extending from the first end of the substrate of that ELA to the second end of the substrate of that ELA, and the substrates of the ELAs in a first set of the ELAs may all be oriented such that the reference axes of the ELAs in the first set of the ELAs are all aligned with one another.

In some implementations, the apparatus may further include a rigid substrate, and the second end of the flexible substrate of each ELA may be mounted to the rigid substrate.

In some implementations, for each ELA in a first set of the ELAs, at least part of the first end of the flexible substrate for that ELA may be located in between the first end and the second end of the flexible substrate for an ELA in a second set of the ELAs, and each ELA in the first set of ELAs may be adjacent to at least one ELA in the second set of ELAs.

In some implementations, the contiguous flexible substrate may be arranged to overlap itself in between the second ends of the substrates in the first set of the ELAs and the second ends of the substrates in the second set of the ELAs.

In some implementations, for each ELA in the first set of the ELAs, another part of the first end of the flexible substrate for that ELA may be located in between the first end and the second end of the flexible substrate for another ELA in the second set of the ELAs.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts a top view of an example electromotive lighting assembly (ELA).

FIG. 5 depicts a top view of another example ELA.

FIGS. 6 through 9 depict a side view of the ELA of FIG. 4 in various states of actuation.

FIG. 10 depicts an example lighting module that features a plurality of ELAs that are arranged along a linear path.

FIG. 11 depicts an implementation similar to that of FIG. 10, except that the ELAs are not mounted to a rigid substrate.

FIG. 12 depicts an implementation similar to that of FIG. 11, but with a much larger flexible substrate and a two-dimensional pattern of ELAs arranged therein.

FIG. 13 depicts an example of a lighting module in which ELAs are positioned in an overlapping manner.

FIG. 14 shows a plan view of an example lighting module.

FIG. 15 shows a side view of the lighting module of FIG. 14.

FIG. 16 depicts another example implementation of a lighting module.

FIGS. 17 through 20 depict an example of another type of lighting module with ELAs.

### DETAILED DESCRIPTION

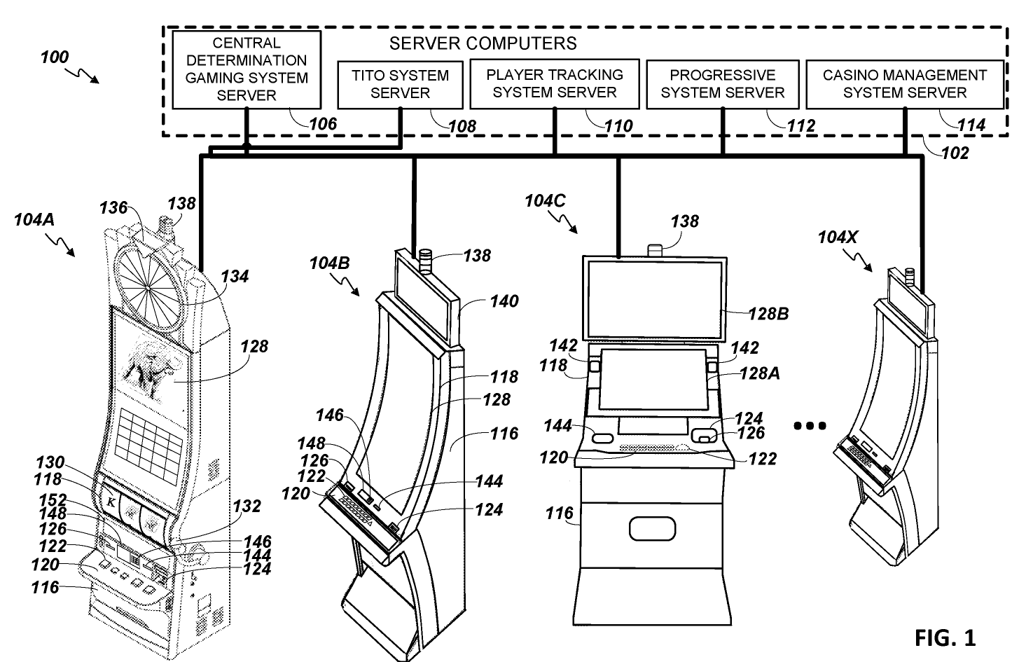

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL^{TM} model gaming device manufactured by Aristocrat^{®} Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

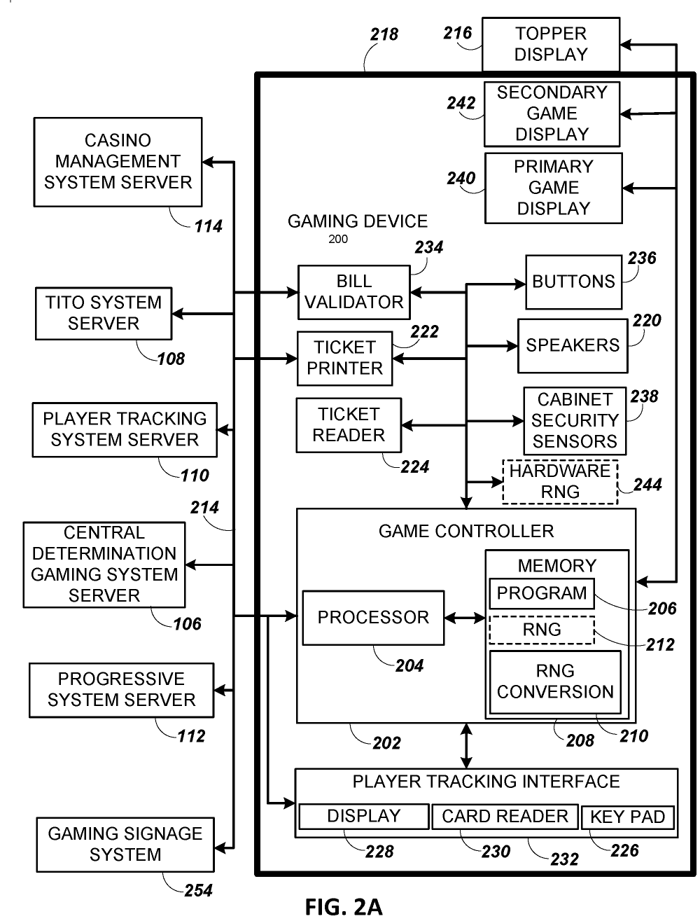

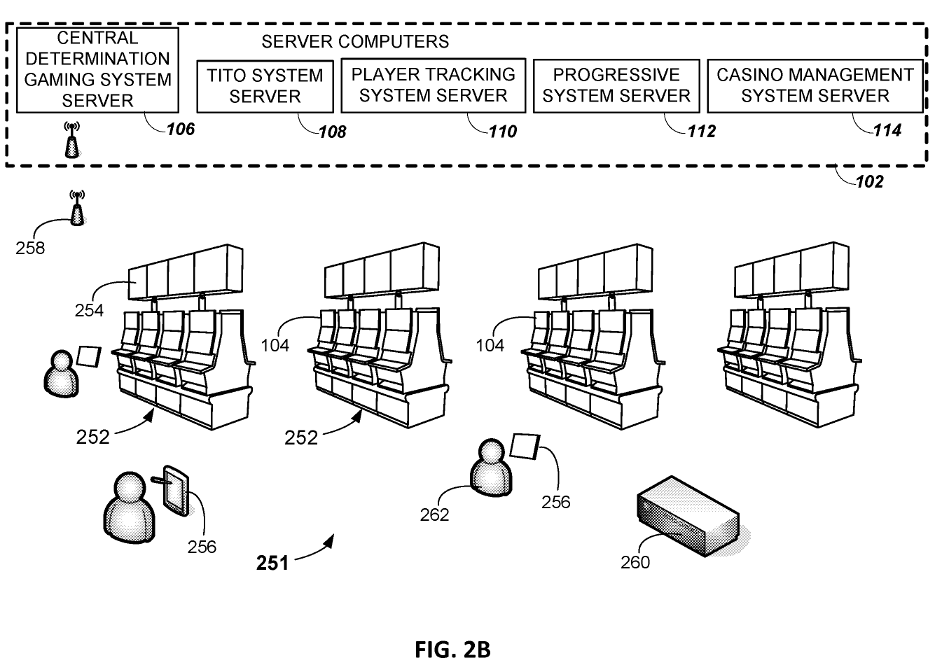

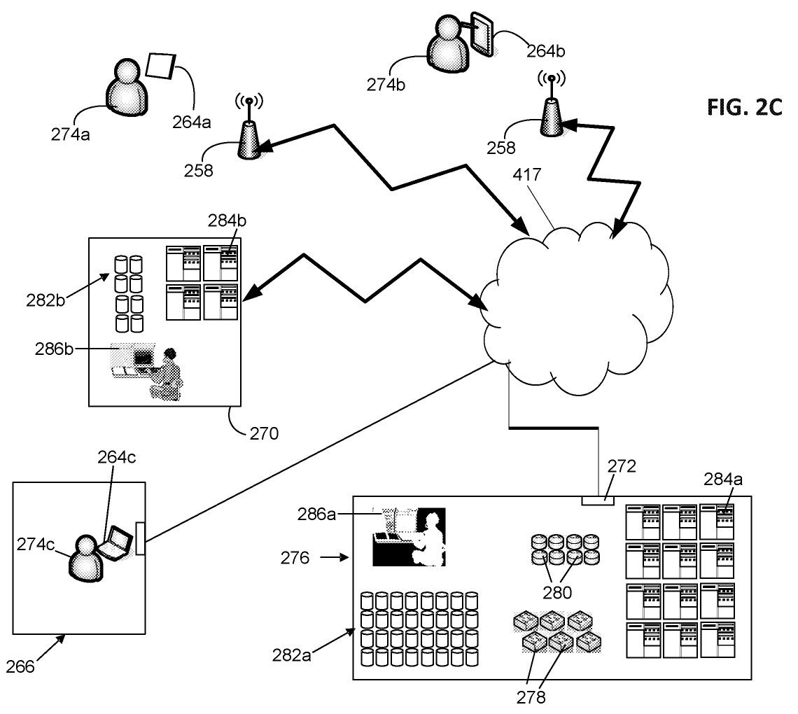

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc^{TM} model gaming device manufactured by Aristocrat^{®} Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix^{TM} model gaming device manufactured by Aristocrat^{®} Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player’s credit value, a ticket reader 224 which reads bar-coded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS^{®} system manufactured by Aristocrat^{®} Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player’s EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a–274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a–274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

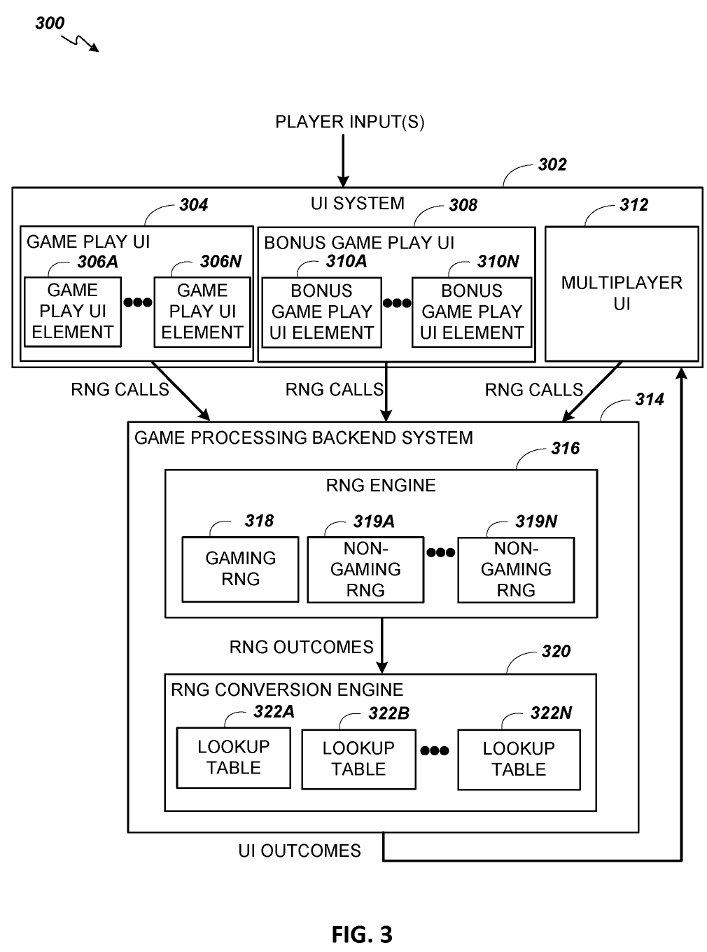

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player’s gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Modern electronic gaming machines may include a variety of electronic devices that may, in aggregate, consume large amounts of electrical power. For example, it is not uncommon for such electronic gaming machines to include one, and possibly multiple high-resolution monitors or displays, a variety of LED lighting systems that provide lighting effects in various locations on the exterior of the EGM, speaker systems, and one or more processing units, including one or more central processing units (CPUs) and potentially one or more graphics processing units (GPUs). When coupled with the fact that such EGMs are typically in service 24 hours a day and seven days a week for extended periods of time, the ongoing power needs of such EGMs, when coupled with the large numbers of such EGMs that may be present in a given casino, represent a significant amount of power consumption. For example, larger casinos may field on the order of 2000 to 3000 EGMs, with each EGM drawing on the order of 100 to 200 watts, although some premium EGMs may have power consumption that is much higher, e.g., on the order of 500 watts or 600 watts or higher. If a casino has, for example 2500 EGMs that each draw, on average, 150 watts of power, the daily power consumption of such a fleet of EGMs may be on the order of 9,000 kWh and may cost hundreds of thousands of dollars per year.

The present disclosure is directed to systems for lighting modules that may be used in an electronic gaming machine to provide attention-grabbing lighting effects in a power-efficient manner, thereby potentially reducing the amount of power needed to operate electronic gaming machines having such lighting modules.

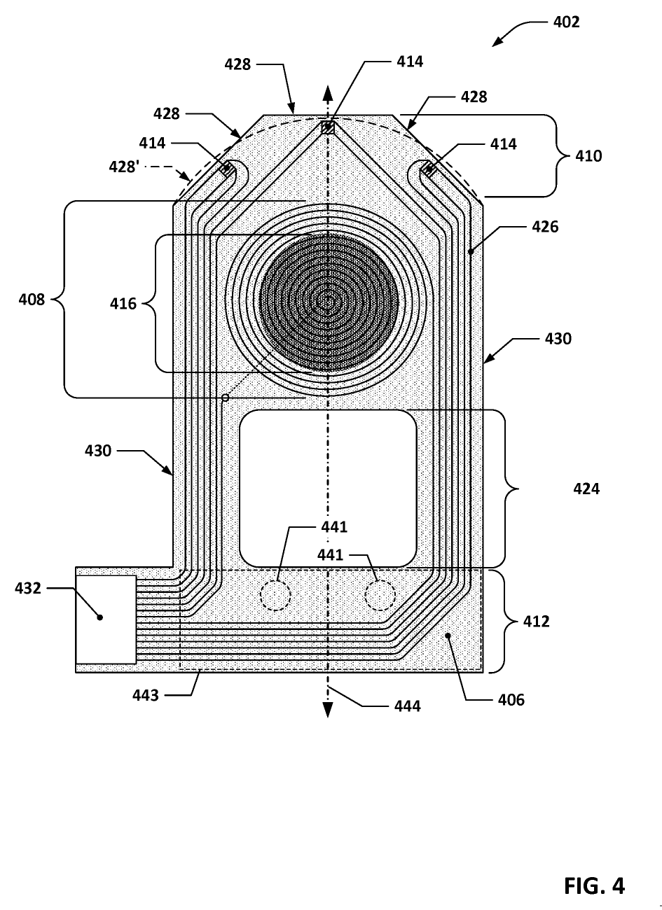

FIG. 4 depicts a top view of an example electromotive lighting assembly (ELA) 402. The ELA 402 may include, for example, a flexible substrate 406 that may extend along a reference axis 444 between a first end 410 and a second end 412 and that may have one or more light sources 414 located at the first end 410 and an electrically conductive coil 408 positioned in between the first end 410 and the second end 412. The one or more light sources 414 may, for example, be surface-mount light-emitting diodes (LEDs), such as red-green-blue (RGB) surface-mount LEDs that may be controllable so as to emit a combined spectrum of light that may reproduce any color of visible light. The flexible substrate 406 may, for example, be made of a material such as a thin polyimide film (such as Kapton®) or a polyester film; such films may be on the order of several thousandths of an inch thick or less. Other specialized thin films or materials may be used as well, as appropriate, e.g., specialized laminates that may be polytetrafluoroethylene-based.

In the implementation shown in FIG. 4, the first end 410 of the ELA 402 has a faceted profile, e.g., with multiple linear edges 428. Two of the edges 428 are at 45° relative to the edge 428 that is interposed between them and are at 45° relative to the sides 430 of the flexible substrate 406 that span between the first end 410 and the second end 412.

In this implementation, there are three light sources 414, each positioned along a different one of the edges 428 and oriented such that the directions of maximum light emission intensity of the light sources 414 are oriented in different directions. In other implementations, there may be a single light source at the first end 410 of the flexible substrate 406, while in yet other implementations, there may be two light sources 414 at the first end 410 of the flexible substrate 406 or more than three light sources 414 at the first end 410 of the flexible substrate 406.

It will be understood that a light source 414, as the term is used herein, generally refers to a single light-emitting package or device that may, for example, include multiple discrete light sources integrated into a single assembly. For example, a surface-mount RGB LED may include three smaller discrete LEDs—a red LED, a blue LED, and a green LED—that may each be individually controllable so as to emit light of different intensities. By varying the intensity of each discrete LED, it is possible cause the RGB LED to emit light of different intensities of red, green, and blue light that, when viewed in aggregate, form light of any desired spectrum visible to the human eye. In the implementation of FIG. 4, for example, each of the light sources 414 is an RGB LED that has four different contact pads or terminals—one for a common ground used by all three of the discrete LEDs within the light source 414 and three additional ones that are used to receive signals for powering the red, blue, and green LEDs. In FIG. 4, the light sources 414 are RGB LEDs such as are described above and there are four traces 426 leading from each light source 414 down to an ELA controller 432. The ELA controller 432 may, for example, be configured to receive signals from one or more other controllers that cause the ELA controller to send different control signals to the various light sources 414, thereby allowing each light source 414 to be individually controllable independently of the other light sources 414 such that each light source 414 can emit different colors and/or intensities of light.

The traces 426 may, as shown in FIG. 4, be routed so as to generally avoid making sharp, 90-degree turns and may instead follow paths that are composed of segments that are at 45° relative to adjoining segments and that have rounded corners where two segments connect. Such an arrangement may avoid issues with fatigue failure in the traces that may arise due to repeated flexing of the flexible substrate 406.

The edges 428 of the first end 410 may, in some instances, be rounded, such as is indicated by edge 428', or flat, e.g., a single linear edge spanning between the sides 430.

The electrically conductive coil 408 may, for example, be fashioned by a trace 426 that is routed in a flat spiral shape. In other implementations, the electrically conductive coil 408 may have other shapes, such as a rectangular, square, or triangular spiral shapes. The electrically conductive coil 408 may, for example, be formed on one or more surfaces or layers of the flexible substrate 406, e.g., on an exterior surface of the flexible substrate 406 or on an interior layer of the flexible substrate 406. The innermost end of the electrically conductive coil may be connected with a trace that is on another layer of the flexible substrate, e.g., via a through-via, that then extends radially outward across all of the loops of the electrically conductive coil 408 (without coming into electrically conductive contact with such loops). Thus, both the interior and exterior ends of the electrically conductive coil 408 may be connected with the ELA controller 432. The ELA controller 432 may be configured to pass a current through the electrically conductive coil 408 in order to create an inductively generated electromagnetic field.

The second end 412 of the flexible substrate 406 may be mounted to a rigid structure, such as a housing, rigid substrate, or other structure such that the first end 410 of the flexible substrate 406, as well as the portion of the flexible substrate 406 between the first end 410 of the flexible substrate 406 and the second end 412 of the flexible substrate 406, is able to be flexed upward, away from the structure that supports the flexible substrate 406. The second end 412 of the flexible substrate 406 may, for example, be bonded to the rigid structure or, in some instances, mechanically attached to the rigid structure, e.g., by screws. In some such implementations, the second end 412 of the flexible substrate 406 may be attached to a rigid or semi-rigid stiffener 443, such as a rectangular plate, or sandwiched between the rigid or semi-rigid stiffener 443 and the rigid structure that has holes 441 therethrough. The rigid or semi-rigid stiffener 443 may, for example, be made of a rigid composite material, plastic, or metal, in some instances. The holes 441 may extend through the second end 412 of the flexible substrate 406, thereby allowing screws to be passed through the rigid or semi-rigid stiffener 443 and the second end 412 of the flexible substrate 406 and into threaded holes in the rigid structure. The flexible substrate 406, for example may be able to be flexed between at least a first position in which the flexible substrate 406 is in a generally undeflected state (or a rest state) and a second position in which the flexible substrate 406 is flexed such that the first end 410 is further from the structure than in the first position.

The ELA 402 may also include a magnet 416 that is fixed in location relative to the second end 412 of the flexible substrate 406. The magnet may be positioned adjacent to the electrically conductive coil 408 when the flexible substrate 406 is in the first position. The magnet 416 may, for example, be a rare-earth magnet, but may also be another form of magnet. The magnet 416 may provide a constant electromagnetic field. When a current is passed through the electrically conductive coil 408 to generate an electromagnetic field, the strength of the electromagnetic field that is generated may depend on the amount of current that is delivered through the electrically conductive coil 408. Thus, the electromagnetic field generated by the magnet 416 may have a field strength that is constant, but the electromagnetic field generated by the electrically conductive coil 408 may have a field strength that is controllable. By applying a current to the electrically conductive coil 408 an electromagnetic field is generated that acts to push against the electromagnetic field emitted by the magnet 416, thereby repelling the electrically conductive coil 408 away from the magnet 416 and causing the electrically conductive coil 408 and the first end 410 of the flexible substrate 406 to lift away from the magnet 416. At a particular level of current, the electrically conductive coil 408 and the flexible substrate 406 is caused to flex into the second position.

The flexible substrate 406 may, in some instances, also include a through-hole 424 that is located between the electrically conductive coil 408 and the second end 412 of the flexible substrate 406. The through-hole 424 may create a region of the flexible substrate 406 that has a lower bending stiffness, thereby decreasing the amount of force required to flex the flexible substrate 406 by a given amount. This, in turn, may decrease the amount of power needed to achieve a particular degree of flexure in the flexible substrate 406.

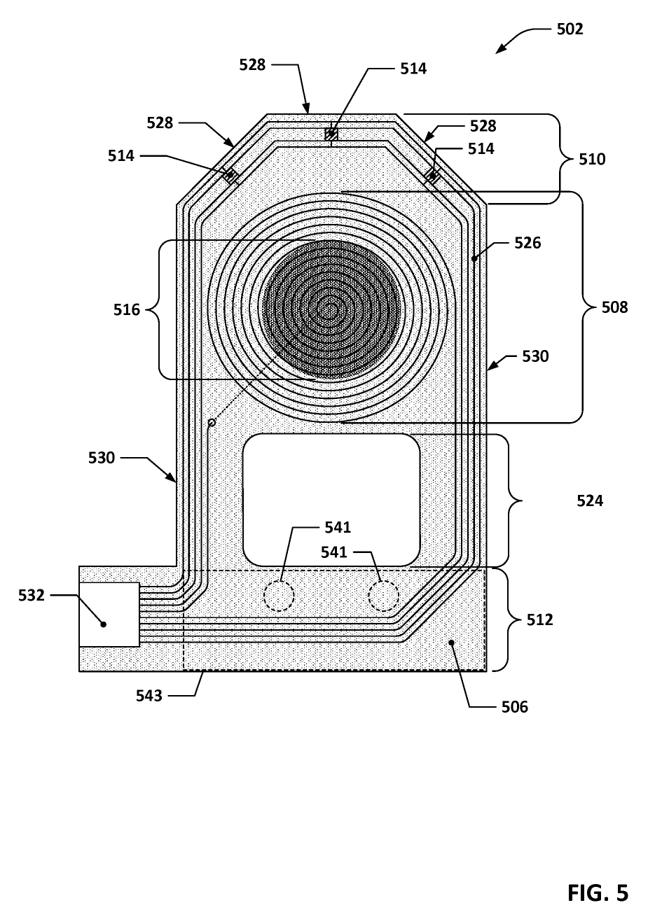

FIG. 5 depicts a top view of another example ELA. This implementation is similar to that of FIG. 4. Elements in FIG. 5 with callouts having the same last two digits as elements in FIG. 4 may be assumed to be similar to such equivalent elements in FIG. 4. The discussion above with respect to such elements will be understood to be applicable to similar elements in FIG. 5. The implementation of FIG. 5 differs from that of FIG. 4 in that the LEDs that are used as the light sources 514 are, instead of each having a separate, dedicated trace for each contact, connected in a serial fashion. For example, each LED may have six contact pads, with one contact pad serving as ground, one providing power (acting as a power supply), and the other four serving as input/output terminals for clock signals and data signals. Such a configuration is, for example, provided in the 587-1016-247F addressable RGB LED offered by Dialight Signals and Components, and allows the same serial and clock signals to be sent to each of the LEDs connected in series. A controller built into the LED package may then interpret such data and clock signals to determine how to control the LEDs in the LED package in order to produce a particular color and/or intensity of light. As can be seen, such an arrangement results in a smaller number of traces that must be routed from the light sources 514 and to the second end 512 of the flexible substrate 506. It will be understood that the implementations of FIG. 5 and 4 are both viable options for use in the further examples below.

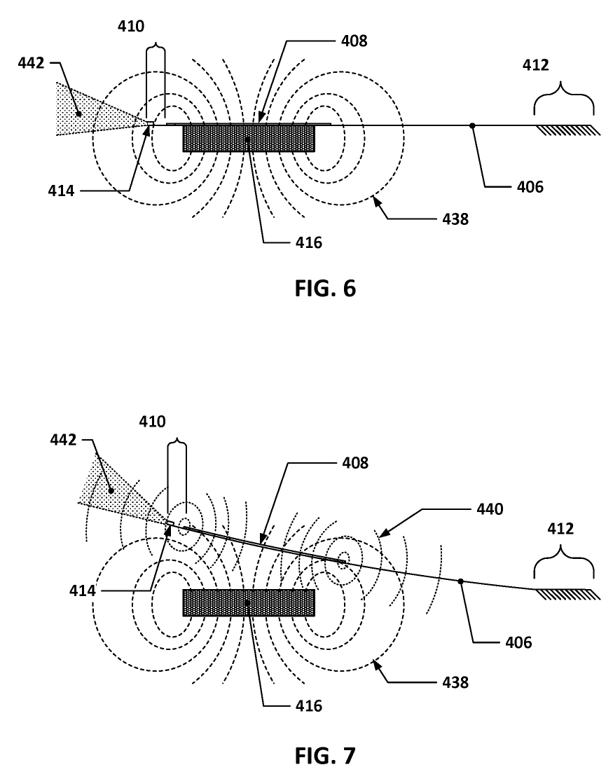

FIGS. 6 through 9 depict a side view of the ELA 400 in various states of actuation. As can be seen in FIG. 6, the light source 414 at the first end 410 of the flexible substrate 406 may be caused to emit light in an illumination region 442. The flexible substrate 406 in FIG. 6 is in the first position, lying flush against the magnet 416 (or against a structure, such as a rigid substrate, that the magnet may be supported by) and with the second end 412 thereof fixed with respect to the magnet 416. As can be seen, the electrically conductive coil 408 is positioned over, and adjacent to, the magnet 416. The electromagnetic field of the magnet 416 is represented by magnetic field lines 438.

In FIG. 7, a current has been applied to the electrically conductive coil 408, thereby causing the electrically conductive coil 408 to emit its own electromagnetic field, represented by electromagnetic field lines 440, that is repelled by the electromagnetic field 438 generated by the magnet 416, thereby causing the flexible substrate 406 to lift away from the magnet 416 and cause the direction of the illumination region 442 to change its direction of maximum intensity. In FIGS. 8 and 9, the amount of current delivered to the electrically conductive coil 408 has been increased, resulting in the electromagnetic field 440 increasing in strength and generating a stronger magnetic repulsion force that forces the flexible substrate 406 further from the magnet 416, e.g., into the second position.

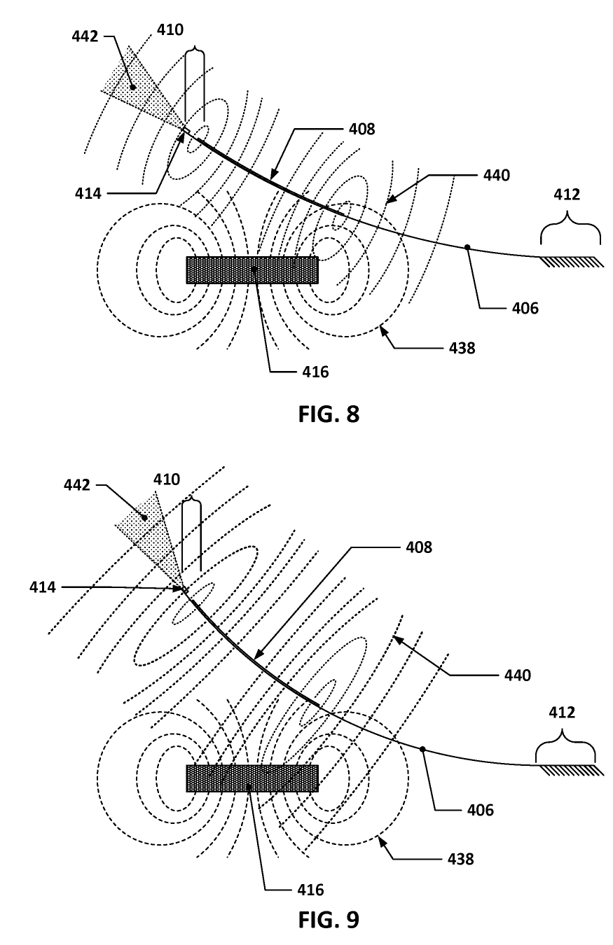

FIG. 10 depicts an example lighting module 1000 that features a plurality of ELAs 1002 that are arranged along a linear path. The ELAs 1002 are similar to the ELA 402 discussed earlier. In this example, the ELAs 1002 are each mounted to a rigid substrate 1018. The rigid substrate 1018 may, for example, be a glass-reinforced epoxy laminate material such as RF4, or other suitable material for printed circuit board manufacturing. For example, the second ends of the flexible substrates of the ELAs 1002 may be bonded to the rigid substrate 1018 with an adhesive or may be clamped in place by a mechanical fastener or other structure. In this example, the ELA controllers 1032 are located on the rigid substrate 1018. The magnets for the ELAs 1002 may be mounted to the rigid substrate 1018.

The arrangement of ELAs 1002 in the lighting module 1000 may be controlled by a module controller 1034 that may communicate with the individual ELA controllers 1032. For simplicity, the connections between the module controller 1034 and the individual ELA controllers 1032 are depicted as single traces, but may, in reality, each include multiple traces.

It will be understood that in FIGS. 4 onwards, elements that are similar in each such figure have callouts that share the same last two digits. In the interest of avoiding repetition, repeat descriptions of such elements are generally avoided and it will be understood that discussion of similar such elements in earlier figures is equally applicable to those similar elements in later figures, unless indicated otherwise.

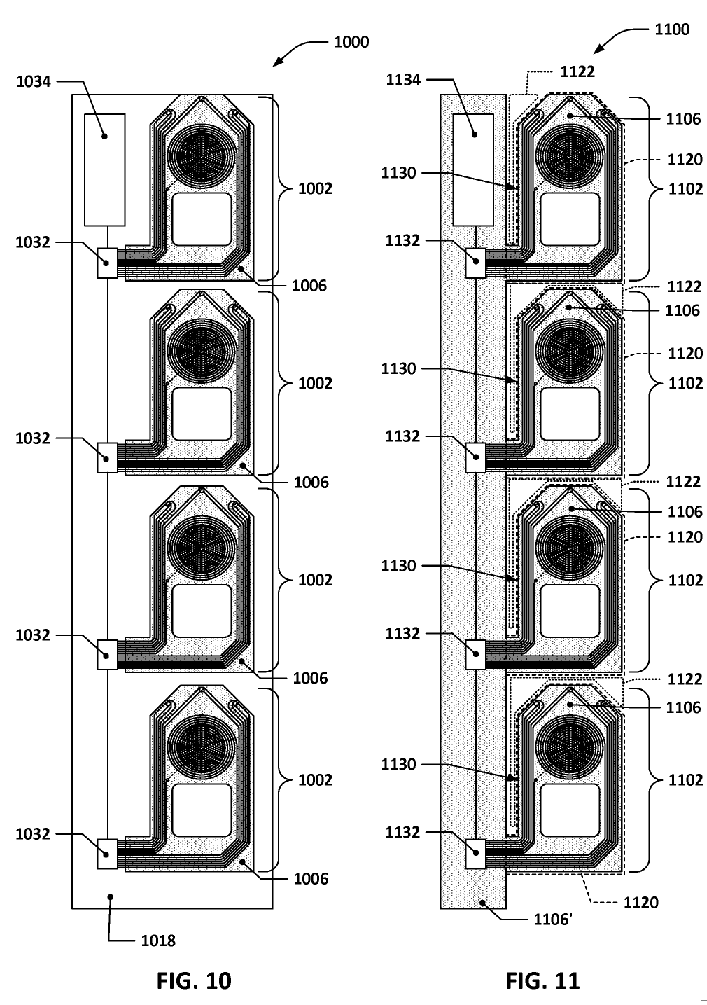

FIG. 11 depicts an implementation similar to that of FIG. 10, except that the ELAs 1102 are not mounted to a rigid substrate such as rigid substrate 1018. In the implementation of FIG. 11, the flexible substrates 1106 of the ELAs 1102 are sub-portions 1120 of a larger flexible substrate 1106'. In this implementation, the flexible substrates 1106 are contiguous with the remainder of the flexible substrate 1106'. Such a construction may be more conducive to installing the lighting module 1100 along, for example, a curved or non-flat surface, and may also be less expensive to manufacture than, for example, the implementation of FIG. 10.

In the implementation of FIG. 11, portions of the flexible substrate 1106' may be removed in order to define the sub-portions 1120 within the larger flexible substrate 1106', e.g., cut-away portions 1122 may be removed from the flexible substrate 1106'. The cut-away portions 1122 may separate the first ends of the flexible substrates 1106 of the ELAs 1102, as well as at least sides 1130 of the flexible substrates 1106 of the ELAs 1102 extending from the first ends of the flexible substrates 1106 of the ELAs 1102 towards the second ends of the flexible substrates 1106 of the ELAs 1102, from portions of the larger, contiguous flexible substrate 1106' adjacent the ELAs 1102.

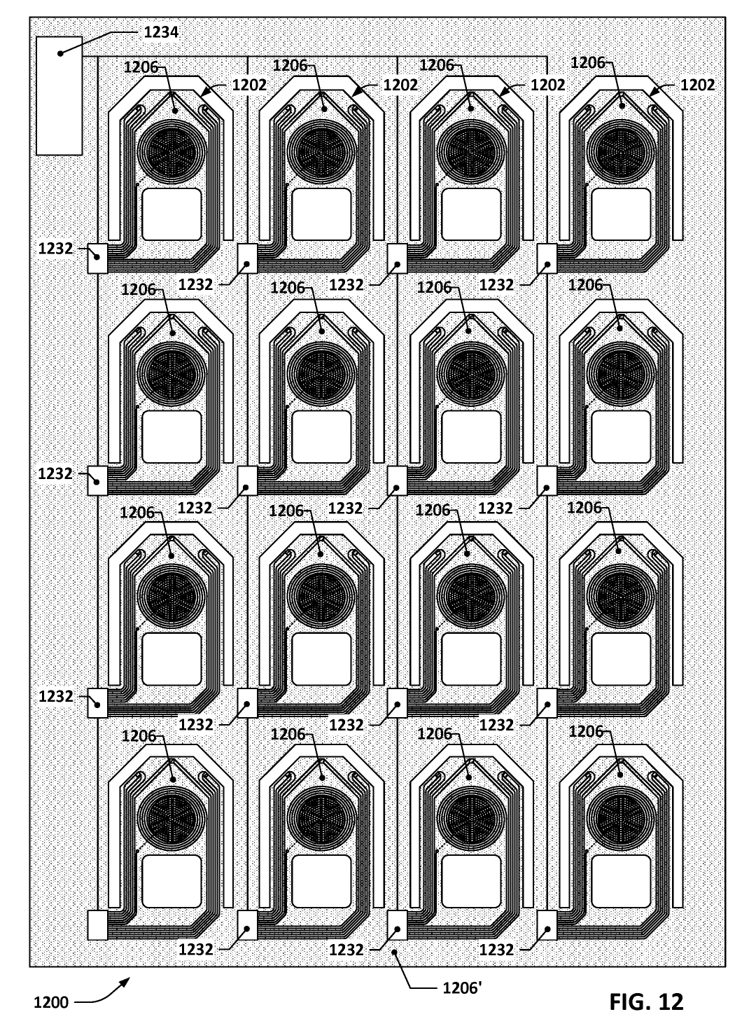

FIG. 12 depicts an implementation similar to that of FIG. 11, but with a much larger flexible substrate 1206' and a two-dimensional pattern of ELAs 1202 arranged therein. The flexible substrates 1206 of the ELAs 1202 are, as in the example of FIG. 11, sub-portions of the larger flexible substrate 1206' that are formed by the removal of cut-away portions, such as the cut-away portions 1122 in the example of FIG. 11. Such cut-away portions may separate the first ends of the flexible substrates 1206 of the ELAs 1202, as well as at least sides of the flexible substrates 1206 of the ELAs 1202 extending from the first ends of the flexible substrates 1206 of the ELAs 1202 towards the second ends of the flexible substrates 1206 of the ELAs 1202, from portions of the larger, contiguous flexible substrate 1206' adjacent the ELAs 1202.

Such an arrangement may, in effect, act like a pixelated display, with each ELA 1202 acting as a single movable “pixel” in the pixelated display. The module controller 1234 may, for example, be operably connected with the ELAs 1202 and configured to be able to individually address and control each ELA 1202 with respect to both the light emission states of the one or more light sources in each ELA 1202 and the movement of the flexible substrate 1206 in each ELA 1202 that may be caused by energizing the electrically conductive coil of that ELA 1202.

In the examples discussed with respect to FIGS. 10 through 12, the ELAs of each lighting module have been arranged along paths or in two-dimensional patterns with no overlap between adjacent ELAs. In other implementations, however, ELAs in a lighting module may be positioned so as to partially overlap, thereby allowing for a denser arrangement of ELAs, which may allow for a higher “resolution” of ELAs to be achieved in a lighting module. For example, some lighting modules may include a first set of ELAs in which, for each ELA in the first set of ELAs, at least part of the first end of the flexible substrate for that ELA is located in between the first end and the second end of the flexible substrate for an ELA in a second set of ELAs that the ELA in the first set is adjacent to.

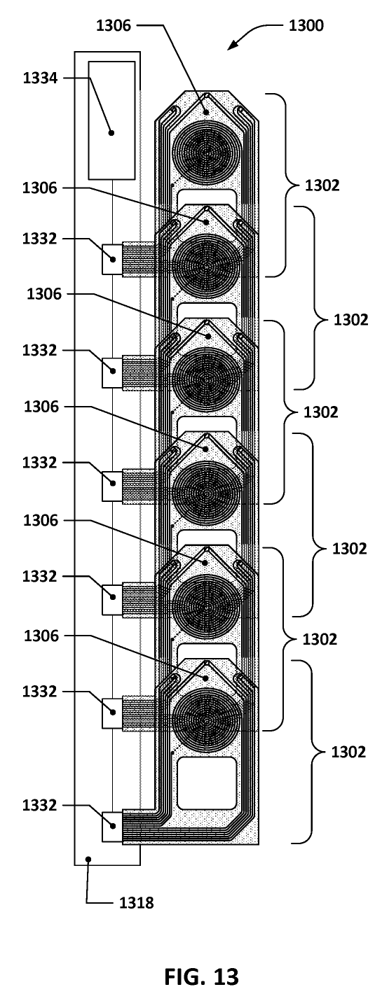

FIG. 13 depicts an example of a lighting module 1300 in which ELAs 1302 are positioned in an overlapping manner. For example, each of the ELAs 1302 other than the ELA 1302 closest to the module controller 1334 has a flexible substrate 1306 in which at least a part (in this instance, all) of the first end of that flexible substrate 1306 is located in between the first end and the second end of the flexible substrate 1306 of an adjacent one of the ELAs 1302. As a result of such spacing, portions of the flexible substrates 1306 of adjacent ELAs 1302 are interposed between the magnets and electrically conductive coils for those ELAs 1302. Depending on the amount of overlap present in such ELA arrangements, there may be instances in which actuation of one ELA 1302, e.g., to move it from its first position to its second position, may also cause some small amount of movement in an ELA 1302 that partially overlaps the actuated ELA 1302. The amount of such sympathetic movement may depend on the amount of actuation in the actuated ELA 1302 and in the amount that the overlapping ELA 1302 extends past the second end of the overlapped ELA 1302 and into the region of the flexible substrate 1306 of the overlapped ELA 1302 in between the first end and the second end of the flexible substrate 1306 of the overlapped ELA 1302. As can be seen from FIG. 13, the number of ELAs 1302 that can be arranged along a path may be increased by at least 50% when overlapped with one another as compared with implementations in which the ELAs 1302 are not overlapped with one another.

In the implementation of FIG. 13, the ELAs 1302 are discrete units, with each ELA 1302 having a separate flexible substrate 1306 that is then connected to a rigid substrate 1318. Similar overlapping arrangements of ELAs may, however, also be implemented in lighting modules featuring a contiguous flexible substrate that provides, via sub-portions thereof, the flexible substrates for multiple ELAs.

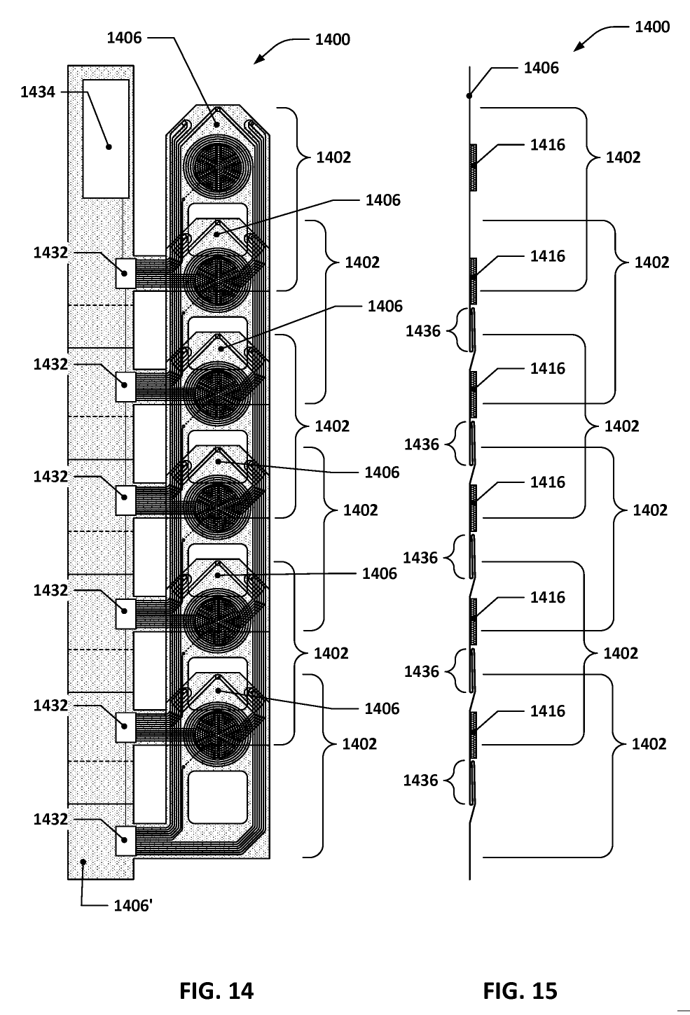

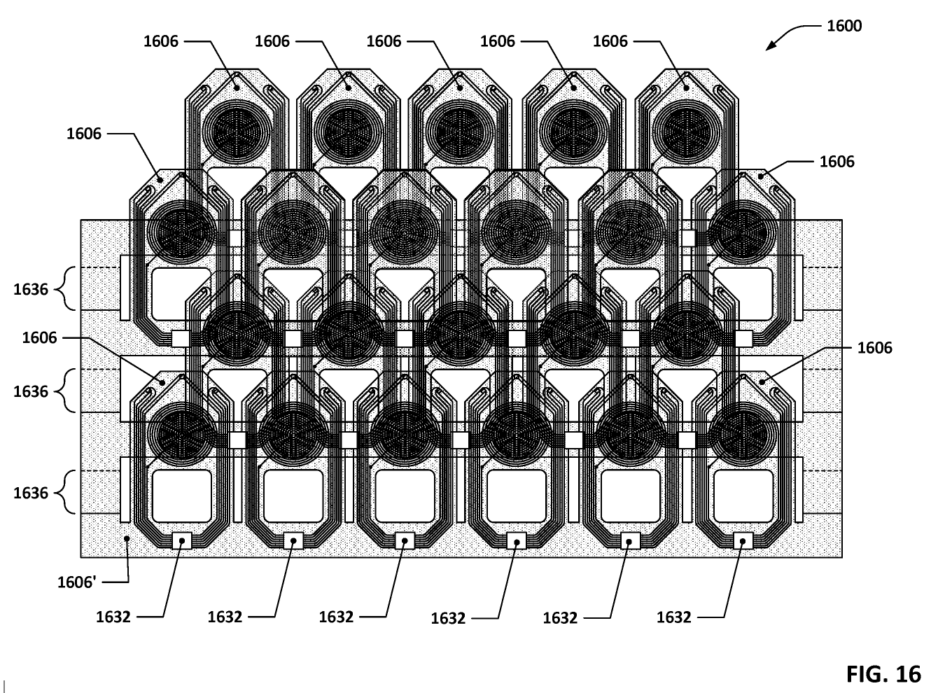

FIGS. 14 and 15 depict an example of such a lighting module. FIG. 14 shows a plan view of such a lighting module 1400, while FIG. 15 shows a side view of the lighting module 1400. In the example of FIGS. 14 and 15, a lighting module 1400 similar to the lighting module 1100 of FIG. 11 is provided, except that the lighting module 1400 has six ELAs 1402 instead of the four ELAs 1102 depicted for the lighting module 1100. The spacing between where the sub-portions that define the flexible substrate 1406 meet the remainder of the larger flexible substrate 1406' is the same in the lighting module 1400 as it is in the lighting module 1100. However, the larger flexible substrate 1406' has been folded back on itself, e.g., in a Z-fold or S-fold manner, in most of the regions in between where the sub-portions that define the flexible substrates 1406 of the ELAs 1402 meet the remainder of the larger flexible substrate 1406'. In these folded regions 1436, which are generally located in between the second ends of adjacent ELAs 1402 (when viewed from the side, e.g., as in FIG. 15), the flexible substrate 1406' overlaps itself due to the double-fold arrangement, thereby allowing the spacing along the reference axes of the ELAs 1402 to be decreased by an amount generally equal to twice the fold length. Such an arrangement provides enhanced flexibility in manufacture, as solder or connector connections between each ELA 1402 and a rigid substrate are avoided and multiple different pitch spacings between ELAs 1402 may be supported by simply varying the amount of the flexible substrate 1406' that is folded over on itself without requiring any modification of the underlying flexible substrate 1406' with respect to the pitch spacing between ELAs prior to such folding.

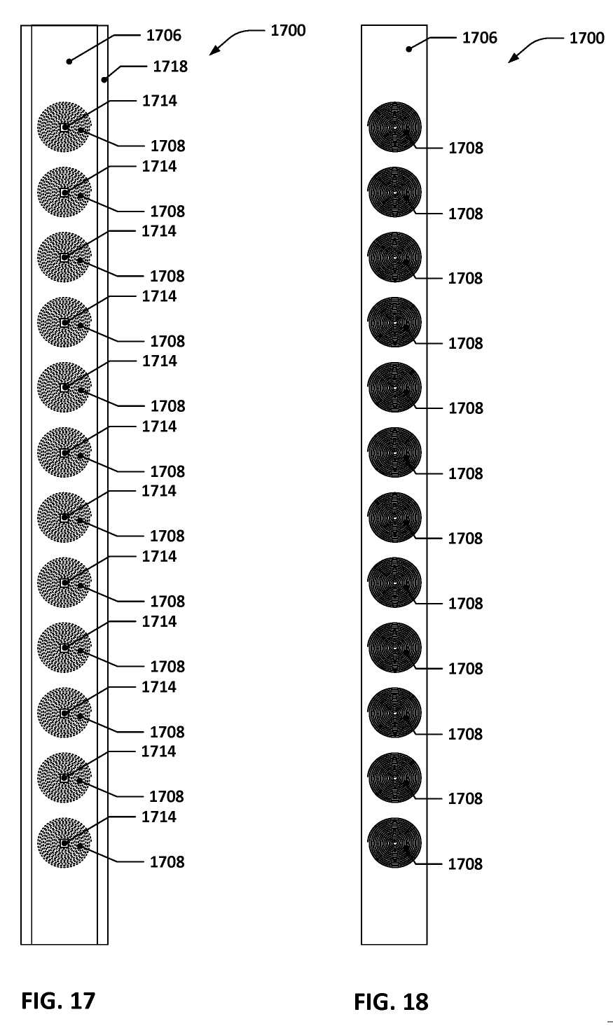

FIG. 16 depicts another example implementation of a lighting module. In the lighting module 1600, twenty-two ELAs have been arranged in a triangular lattice pattern, e.g., in four rows with alternating amounts of 5 and 6 ELAs in each row. The ELAs are not individually labeled with a callout, but the spiral electrically conductive coil of each ELA is clearly visible, and the flexible substrates 1606 of some of the ELAs are explicitly called out. In this example, the ELA controllers 1632 are located within the second end of the ELAs, although other positions are possible as well. A module controller is not depicted, but it will be understood that the ELA controllers 1632 may be connected with a module controller, e.g., as in previous examples, in order to provide a control mechanism for all of the ELAs in the lighting module 1600.

In a configuration similar to that of FIGS. 14 and 15, the ELAs in FIG. 16 have flexible substrates 1606 that are sub-portions of a larger, contiguous flexible substrate 1606'. Portions of the larger, contiguous flexible substrate 1606' located in between the second ends of the flexible substrates 1606 of the ELAs may be folded back on themselves, thereby causing such portions to overlap other portions of the larger, contiguous flexible substrate 1606' and permitting the spacing between the ELAs in directions parallel to the reference axes of the ELAs (see reference axis 444 in FIG. 4) to be reduced.

In the implementation of FIG. 16, the ELAs in each row of ELAs are offset in directions perpendicular to the reference axis by approximately half the width of each ELA from the ELAs in the adjacent row or rows of ELAs, thereby allowing flexible substrate 1606 of each ELA in the bottom three rows of ELAs (except the outermost ELAs in each such row) to overlap two of the ELAs in an adjoining row. For example, as with the example of FIGS. 14 and 15, this allows at least part of the first end of the flexible substrate 1606 for each such ELA to be located in between the first end and the second end of the flexible substrate 1606 for an ELA in a second set of the ELAs in the row and for another part of the first end of the flexible substrate 1606 for each such ELA to be located in between the first end and the second end of the flexible substrate 1606 for a different ELA in the second set of the ELAs. Such an arrangement may give the appearance of scales, e.g., lizard, fish, or dragon scales, that may be actuated so as to ripple, waver, or otherwise move and to be caused to emit light of different intensities/and wavelengths.

It will be noted that the ELAs in the above examples generally have their reference axes, e.g., as shown by callout 444 in FIG. 4, all oriented in the same direction or aligned with one another. However, in other implementations, the orientations of the ELAs may exhibit a different aspect, e.g., arranged in an unaligned manner. For example, they may be arranged in a circular array, e.g., like flower petals, or in rows in which the ELAs within a row have parallel reference axes, but the reference axes for each row may be oriented to be non-parallel with the reference axes of the ELAs in adjacent rows.

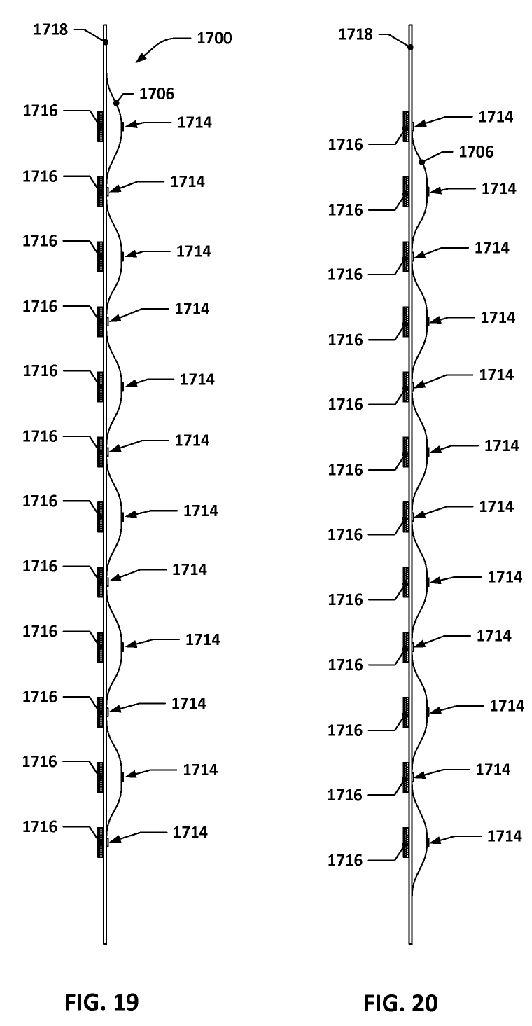

FIGS. 17 through 20 depict an example of another type of lighting module with ELAs. FIG. 17 shows a front view of a lighting module 1700 that has a single, long flexible substrate 1706, e.g., a strip, that is fixed at either end to a rigid substrate 1718. The flexible substrate 1706 is longer in length than the distance between the fixed ends thereof, such that there is slack in the flexible substrate 1706. The flexible substrate 1706 may also have a linear array of electrically conductive coils 1708 arranged along its back side, as is shown in FIG. 18, and may have light sources 1714 arranged along its front side, as shown in FIG. 17. A series of magnets 1716, as is shown in FIG. 19, may be affixed to the rigid substrate 1718 and positioned so as to be proximate to the electrically conductive coils 1708.

When current is selectively directed through the electrically conductive coils 1708, each electrically conductive coil 1708 through which current is directed may emit an electromagnetic field that may act to repel the electrically conductive coil 1708 and the flexible substrate 1706 in the immediate vicinity thereof away from the magnet 1716 that is closest thereto. When such current is removed from an electrically conductive coil 1708, the electromagnetic field generated thereby may cease to exist, and the flexible substrate 1706 in that area may then relax back into an at-rest state. By selectively energizing the electrically conductive coils 1708, it is possible to cause the flexible substrate 1706 to undergo various movements. For example, by sequentially energizing and then de-energizing the electrically conductive coils 1708, successive portions of the flexible substrate 1706 may be caused to flex away from the rigid substrate 1718, giving the appearance of a moving wave. When the light sources 1714 are energized during such movements, it may generate the appearance of an undulating light source. In another example, alternating sets of electrically conductive coils 1708 may be energized and de-energized to cause alternating segments of the flexible substrate 1706 to move towards and away from the rigid substrate 1718, as shown in FIGS. 19 and 20.

The lighting modules discussed herein may be mounted to electronic gaming machines, e.g., as edge lighting or as side panel lighting. For example, the linear strip lights shown in earlier implementations may be used as edge lighting, whereas the two-dimensional pattern lighting modules may be used to cover side panels or front panels of such gaming machines.

It is to be understood that the phrases “for each <item> of the one or more <items>,” “each <item> of the one or more <items>,” or the like, if used herein, are inclusive of both a single-item group and multiple-item groups, i.e., the phrase “for … each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items. Similarly, the term “set” or “subset” should not be viewed, in itself, as necessarily encompassing a plurality of items—it will be understood that a set or a subset can encompass only one member or multiple members (unless the context indicates otherwise).

The use, if any, of ordinal indicators, e.g., (a), (b), (c)… or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The present disclosure provides at least the following numbered implementations.

Implementation 1: An apparatus including: a plurality of electromotive lighting assemblies (ELAs); and one or more controllers, wherein: each ELA includes: a flexible substrate having an electrically conductive coil located therein or thereon and in between a first end of the flexible substrate and a second end of the flexible substrate, wherein the flexible substrate is configured to be able to flex between at least a first position and a second position, one or more light sources located at the first end of the flexible substrate, and a magnet that is mounted in a fixed location relative to the second end of the flexible substrate, wherein the magnet is positioned adjacent the electrically conductive coil when the flexible substrate is in the first position; the ELAs are arranged along a path or in a two-dimensional pattern; and the one or more controllers are operably connected with the one or more light sources and the electrically conductive coil in each of the ELAs and configured to control a light emission state of each of the one or more light sources in each of the ELAs and to control movement of the flexible substrate in each of the ELAs from the corresponding first position to the corresponding second position.

Implementation 2: The apparatus of implementation 1, wherein the apparatus includes a contiguous flexible substrate, wherein: the flexible substrate of each ELA is provided by a corresponding sub-portion of the contiguous flexible substrate, and the contiguous flexible substrate has, for each ELA, a cut-away portion separating the first end of the flexible substrate of that ELA, as well at least one side of the flexible substrate of that ELA extending from the first end of the flexible substrate of that ELA towards the second end of the flexible substrate of that ELA, from portions of the contiguous flexible substrate adjacent that ELA.

Implementation 3: The apparatus of implementation 2, wherein, for each ELA in a set of the ELAs, the flexible substrate of that ELA has a through-hole located in between the second end of the flexible substrate of that ELA and the electrically conductive coil of that ELA.

Implementation 4: The apparatus of implementation 1, wherein, for each ELA in a first set of the ELAs, the one or more light sources for that ELA include surface-mount light-emitting diodes.

Implementation 5: The apparatus of implementation 4, wherein, for each ELA in the first set of the ELAs, the one or more light sources of that ELA include multiple light sources.

Implementation 6: The apparatus of implementation 5, wherein, for each ELA in a second set of the ELAs in the first set of the ELAs, the first end of the flexible substrate of that ELA defines a rounded or faceted edge and the multiple light sources of that ELA are arranged adjacent the rounded or faceted edge such that they have different directions of maximum light emission intensity when caused to emit light.

Implementation 7: The apparatus of implementation 1, wherein the ELAs are arranged along a path, one after another.

Implementation 8: The apparatus of implementation 1, wherein the ELAs are arranged in a two-dimensional pattern.

Implementation 9: The apparatus of implementation 8, wherein, for each ELA in a first set of the ELAs, at least part of the first end of the flexible substrate for that ELA is located in between the first end and the second end of the flexible substrate for an ELA in a second set of the ELAs, wherein each ELA in the first set of ELAs is adjacent to at least one ELA in the second set of ELAs.

Implementation 10: The apparatus of implementation 9, wherein the contiguous flexible substrate is arranged to overlap itself in between the second ends of the substrates in the first set of the ELAs and the second ends of the substrates in the second set of the ELAs.

Implementation 11: The apparatus of implementation 9, wherein, for each ELA in the first set of the ELAs, another part of the first end of the flexible substrate for that ELA is located in between the first end and the second end of the flexible substrate for another ELA in the second set of the ELAs.

Implementation 12: The apparatus of implementation 1, wherein: each ELA has a reference axis extending from the first end of the substrate of that ELA to the second end of the substrate of that ELA, and the substrates of the ELAs in a first set of the ELAs are all oriented such that the reference axes of the ELAs in the first set of the ELAs are all aligned with one another.

Implementation 13: The apparatus of implementation 1, further including a rigid substrate, wherein the second end of the flexible substrate of each ELA is mounted to the rigid substrate.

Implementation 14: The apparatus of implementation 13, wherein, for each ELA in a first set of the ELAs, at least part of the first end of the flexible substrate for that ELA is located in between the first end and the second end of the flexible substrate for an ELA in a second set of the ELAs, wherein each ELA in the first set of ELAs is adjacent to at least one ELA in the second set of ELAs.

Implementation 15: The apparatus of implementation 14, wherein the contiguous flexible substrate is arranged to overlap itself in between the second ends of the substrates in the first set of the ELAs and the second ends of the substrates in the second set of the ELAs.

Implementation 16: The apparatus of implementation 14, wherein, for each ELA in the first set of the ELAs, another part of the first end of the flexible substrate for that ELA is located in between the first end and the second end of the flexible substrate for another ELA in the second set of the ELAs.

Implementation 17: The apparatus of implementation 1, wherein, for each ELA in a first set of the ELAs, the flexible substrate of that ELA has a through-hole located in between the second end of the flexible substrate of that ELA and the electrically conductive coil of that ELA.

Implementation 18: The apparatus of implementation 1, wherein the magnet of each ELA in a first set of the ELAs includes a rare-earth magnet.

Implementation 19: The apparatus of implementation 1, wherein the electrically conductive coil of each ELA in a first set of the ELAs has a spiral shape.

Implementation 20: The apparatus of implementation 1, wherein the flexible substrate of each ELA in a first set of the ELAs includes a polyimide film.

Implementation 21: An apparatus including: a flexible substrate having a first end and a second end, wherein the first end and the second end are each fixed relative to a rigid substrate and wherein the flexible substrate has a length between the first end and the second end that is greater than a distance between the first end and the second end when the flexible substrate is in an undeflected state; a plurality of electrically conductive coils arranged along the flexible substrate in between the first end and the second end; a plurality of light sources arranged along the flexible substrate; a plurality of magnets mounted to the rigid substrate, wherein each magnet of the plurality of magnets is positioned proximate to a corresponding one of the electrically conductive coils; and one or more controllers operably connected with the plurality of light sources and the plurality of electrically conductive coils and configured to selectively direct current through the electrically conductive coils to cause portions of the flexible substrate to flex away from the rigid substrate.

Implementation 22: The apparatus of implementation 21, wherein the one or more controllers are configured to sequentially energize and de-energize the electrically conductive coils to cause successive portions of the flexible substrate to flex away from the rigid substrate.

Implementation 23: The apparatus of implementation 21, wherein the one or more controllers are configured to energize alternating sets of the electrically conductive coils to cause alternating segments of the flexible substrate to move towards and away from the rigid substrate.

Implementation 24: The apparatus of implementation 21, wherein each electrically conductive coil of the electrically conductive coils has a spiral shape.

Implementation 25: The apparatus of implementation 21, wherein the electrically conductive coils are arranged in a linear array along the flexible substrate.

Implementation 26: The apparatus of implementation 21, wherein the flexible substrate includes one or more polyimide films.

Implementation 27: The apparatus of implementation 21, wherein each magnet of the plurality of magnets is a rare-earth magnet.

Implementation 28: The apparatus of implementation 21, wherein the light sources are surface-mount light-emitting diodes.

It is to be further understood that the above disclosure, while focusing on a particular example implementation or implementations, is not limited to only the discussed example, but may also apply to similar variants and mechanisms as well, and such similar variants and mechanisms are also considered to be within the scope of this disclosure.

What is claimed is:

1. An apparatus comprising:
a plurality of electromotive lighting assemblies (ELAs); and
one or more controllers, wherein:
each ELA includes:
a flexible substrate having an electrically conductive coil located therein or thereon and in between a first end of the flexible substrate and a second end of the flexible substrate, wherein the flexible substrate is configured to be able to flex between at least a first position and a second position,
one or more light sources located at the first end of the flexible substrate, and
a magnet that is mounted in a fixed location relative to the second end of the flexible substrate, wherein the magnet is positioned adjacent the electrically conductive coil when the flexible substrate is in the first position;
the ELAs are arranged along a path or in a two-dimensional pattern; and
the one or more controllers are operably connected with the one or more light sources and the electrically conductive coil in each of the ELAs and configured to control a light emission state of each of the one or more light sources in each of the ELAs and to control movement of the flexible substrate in each of the ELAs from the corresponding first position to the corresponding second position.

2. The apparatus of claim 1, wherein the apparatus includes a contiguous flexible substrate, wherein:
the flexible substrate of each ELA is provided by a corresponding sub-portion of the contiguous flexible substrate, and
the contiguous flexible substrate has, for each ELA, a cut-away portion separating the first end of the flexible substrate of that ELA, as well at least one side of the flexible substrate of that ELA extending from the first end of the flexible substrate of that ELA towards the second end of the flexible substrate of that ELA, from portions of the contiguous flexible substrate adjacent that ELA.

3. The apparatus of claim 2, wherein, for each ELA in a set of the ELAs, the flexible substrate of that ELA has a through-hole located in between the second end of the flexible substrate of that ELA and the electrically conductive coil of that ELA.

4. The apparatus of claim 1, wherein, for each ELA in a first set of the ELAs, the one or more light sources for that ELA include surface-mount light-emitting diodes.

5. The apparatus of claim 4, wherein, for each ELA in the first set of the ELAs, the one or more light sources of that ELA include multiple light sources.

6. The apparatus of claim 5, wherein, for each ELA in a second set of the ELAs in the first set of the ELAs, the first end of the flexible substrate of that ELA defines a rounded or faceted edge and the multiple light sources of that ELA are arranged adjacent the rounded or faceted edge such that they have different directions of maximum light emission intensity when caused to emit light.

7. The apparatus of claim 1, wherein the ELAs are arranged along a path, one after another.

8. The apparatus of claim 1, wherein the ELAs are arranged in a two-dimensional pattern.

9. The apparatus of claim 8, wherein, for each ELA in a first set of the ELAs, at least part of the first end of the flexible substrate for that ELA is located in between the first end and the second end of the flexible substrate for an ELA in a second set of the ELAs, wherein each ELA in the first set of ELAs is adjacent to at least one ELA in the second set of ELAs.

10. The apparatus of claim 9, wherein the contiguous flexible substrate is arranged to overlap itself in between the second ends of the substrates in the first set of the ELAs and the second ends of the substrates in the second set of the ELAs.

11. The apparatus of claim 9, wherein, for each ELA in the first set of the ELAs, another part of the first end of the flexible substrate for that ELA is located in between the first end and the second end of the flexible substrate for another ELA in the second set of the ELAs.

12. The apparatus of claim 1, wherein:
each ELA has a reference axis extending from the first end of the substrate of that ELA to the second end of the substrate of that ELA, and
the substrates of the ELAs in a first set of the ELAs are all oriented such that the reference axes of the ELAs in the first set of the ELAs are all aligned with one another.

13. The apparatus of claim 1, further comprising a rigid substrate, wherein the second end of the flexible substrate of each ELA is mounted to the rigid substrate.

14. The apparatus of claim 13, wherein, for each ELA in a first set of the ELAs, at least part of the first end of the flexible substrate for that ELA is located in between the first end and the second end of the flexible substrate for an ELA in a second set of the ELAs, wherein each ELA in the first set of ELAs is adjacent to at least one ELA in the second set of ELAs.

15. The apparatus of claim 14, wherein the contiguous flexible substrate is arranged to overlap itself in between the second ends of the substrates in the first set of the ELAs and the second ends of the substrates in the second set of the ELAs.

16. The apparatus of claim 14, wherein, for each ELA in the first set of the ELAs, another part of the first end of the flexible substrate for that ELA is located in between the first end and the second end of the flexible substrate for another ELA in the second set of the ELAs.

17. The apparatus of claim 1, wherein, for each ELA in a first set of the ELAs, the flexible substrate of that ELA has a through-hole located in between the second end of the flexible substrate of that ELA and the electrically conductive coil of that ELA.

18. The apparatus of claim 1, wherein the magnet of each ELA in a first set of the ELAs includes a rare-earth magnet.

19. The apparatus of claim 1, wherein the electrically conductive coil of each ELA in a first set of the ELAs has a spiral shape.

20. The apparatus of claim 1, wherein the flexible substrate of each ELA in a first set of the ELAs includes a polyimide film.
